(19) United States
(12) Patent Application Publication
(10) Pub. No.: US 2026/0237650 A1
(43) Pub. Date: Aug. 13, 2026

(54) METHOD FOR THE MANUFACTURE OF A CATHODE ACTIVE MATERIAL

(71) Applicant: Virginia Tech Intellectual Properties, Inc., Blacksburg, VA (US)

(72) Inventors: Feng Lin, Christiansburg, VA (US); Junyi Yao, Blacksburg, VA (US)

(21) Appl. No.: 19/537,928

(22) Filed: Feb. 12, 2026

Related U.S. Application Data
(60) Provisional application No. 63/758,035, filed on Feb. 13, 2025.

(51) Int. Cl. H01M 4/505; H01M 4/58

(52) U.S. Cl. CPC H01M 4/505; H01M 4/5825

(57) ABSTRACT

A method for the manufacture of a cathode active material includes contacting a transition metal oxyhydroxide with an alkali metal source to form an oxyhydroxide intermediate having alkali metal cations inserted therein, and heat treating the oxyhydroxide intermediate to form the cathode active material. Cathode active materials and oxyhydroxide metal precursor compositions are also described herein.

### CROSS REFERENCE TO RELATED APPLICATIONS

This application claims priority to U.S. Provisional Patent Application No. 63/758,035, filed on Feb. 13, 2025, the contents of which are hereby incorporated by reference in their entirety.

### BACKGROUND

Solid-state synthesis underpins the manufacturing of complex functional oxides for modern energy, electronic, and catalytic technologies. Yet, this method remains empirical and energy intensive, burdened by sluggish solid-state diffusion and the requirement to reconstruct atomic order from randomly mixed precursors. Thermodynamically, this difficulty arises because reactions must navigate a convoluted free-energy landscape populated by nonequilibrium intermediates rather than descending directly to the ground state. When these intermediates possess a large topological dissimilarity with the target phase, requiring extensive bond breaking, the system confronts a prohibitive kinetic barrier, necessitating high thermal budgets.

It would therefore be advantageous to provide improved methods that overcome the above-described technical challenges.

### SUMMARY

An aspect of the present disclosure is method for the manufacture of a cathode active material, the method comprising: contacting a transition metal oxyhydroxide with an alkali metal source under conditions effective to form an oxyhydroxide intermediate having alkali metal cations inserted therein; and heat treating the oxyhydroxide intermediate to form the cathode active material.

Another aspect is a cathode active material made by the method.

Another aspect is an oxyhydroxide metal composition of the formula TMOOH_{2-δ}.

The above described and other features are exemplified by the following figures and detailed description.

### BRIEF DESCRIPTION OF THE DRAWINGS

The following figures are exemplary embodiments wherein the like elements are numbered alike.

FIG. 1 shows crystallographic trajectory of the conventional solid-state synthesis of LiNiO₂. Thermal dehydration of the layered hydroxide precursor (P3̅m1) triggers a topological collapse into a disordered rock-salt intermediate (Fm3̅m), characterized by random cation mixing (c-LiₓNi₂₋ₓO₂). Transforming this scrambled lattice into the ordered layered target (R3̅m) requires an energy-intensive reconstructive process involving extensive bond breaking and reformation.

FIG. 2 shows in situ synchrotron X-ray diffraction intensity map showing the temperature-dependent evolution of structural ordering, highlighting the delayed development of interlayer ordering upon heating. X-ray wavelength is 0.6199 Å.

FIG. 3 shows representative diffraction patterns with Rietveld refinement at low (250° C.) and high (650° C.) temperatures, showing dehydration accompanied by loss of interlayer ordering due to removal of interlayer molecule water at low temperature, followed by lithiation and the subsequent recovery of interlayer ordering upon further heating.

FIG. 4 shows phase evolution diagram extracted from Rietveld refinement, revealing the dominance of rock-salt intermediate at a broad temperature window and the kinetically delayed emergence of the layered phase at elevated temperature.

FIG. 5 shows time-resolved evolution of the (003) peak recorded during isothermal holding experiments at different temperatures (600-700° C.).

FIG. 6 shows kinetic analysis of the layering process derived from the temporal evolution of the refined layered phase fraction. The semi-logarithmic plots follow a linear relationship, fitting the first-order reaction model.

FIG. 7 shows Arrhenius plot derived from the isothermal rate constants, yielding an activation energy of 205 kJ mol⁻¹ for the rock-salt-to-layered transformation. X-ray wavelength is 0.1665 Å.

FIG. 8 shows Rietveld refinement of a representative sample calcined at 550° C. for 1 week, showing the stubborn coexistence of layered and rock-salt phases.

FIG. 9 shows phase fractions across various Ni-rich compositions after extended sintering at low temperature (550° C.), revealing that Co/Mn doping increases the fraction of the trapped rock-salt phase. The transformation from the rock-salt to the layered phase can take weeks to months to complete at 550° C.

FIG. 10 shows temperature-resolved in situ synchrotron XRD contour plot captured during heating of the NMC811-oxyhydroxide precursor mixed with LiOH. The persistence of the (00x)_{L} reflection (white arrow) and the emergence of the characteristic (104)_{L} reflection (orange arrow) confirm the formation of the R3̅m lithiated oxyhydroxide intermediate. This evidences a direct structural evolution that preserves the crystallographic topology, contrasting with the phase collapse seen in conventional routes. X-ray wavelength is 0.181 Å.

FIG. 11 shows a schematic illustration of the direct layered-to-layered transformation via Li⁺/H⁺ exchange. This topotactic pathway preserves the entire transition metal-oxygen host framework of the precursor (TMOOH_{2-δ}) allowing for direct conversion to the layered target (L-LiₓTM₂₋ₓO₂) without structural collapse along interlayer stacking direction.

FIG. 12 shows Neutron powder diffraction (NPD) coupled with Rietveld refinement identifying the intermediate as a protonated layered phase (Li_{y}H_{2-δ-y}TMO₂).

FIG. 13 shows normalized X-ray Near Edge Absorption Spectra (XANES) tracking the oxidation state change after the chemical oxidation of NMC811 hydroxide precursor.

FIG. 14 shows temperature-resolved in situ synchrotron XRD contour plots monitoring the lithiation of micron-sized oxyhydroxide precursors prepared via concentrated LiOH solution infiltration at low temperature (80° C.). The samples were processed by vacuum drying to remove crystal water (denoted as LiOH infiltration).

FIG. 15 shows temperature-resolved in situ synchrotron XRD contour plots monitoring the lithiation of micron-sized oxyhydroxide precursors prepared via concentrated LiOH solution infiltration at low temperature (80° C.). The samples were processed by ambient drying to retain LiOH·H₂O (denoted as LiOH·H₂O). The ambient-dried route effectively stabilizes the layered structure.

FIG. 16 shows Rietveld refinements of ex situ neutron powder diffraction (NPD) patterns for the vacuum-dried samples, retrieved after a 5-minute isothermal hold at 300° C.

FIG. 17 shows Rietveld refinements of ex situ neutron powder diffraction (NPD) patterns for the ambient-dried samples, retrieved after a 5-minute isothermal hold at 300° C.

FIG. 18 shows Rietveld refinements of ex situ neutron powder diffraction (NPD) patterns after annealing the ambient-dried sample at 475° C. for 15 hours.

FIG. 19 shows depth-resolved Ni L edge soft XAS spectra collected in surface-sensitive TEY mode.

FIG. 20 shows depth-resolved Ni L edge soft XAS spectra collected in bulk-sensitive FY mode.

FIG. 21 shows depth-resolved Ni L edge soft XAS spectra collected in surface-sensitive TEY mode.

FIG. 22 shows depth-resolved Ni L edge soft XAS spectra collected in bulk-sensitive FY mode.

FIG. 23 shows TEM images (with magnified regions) showing microstructural evolution during topotactic Li⁺/H⁺ exchange and subsequent annealing at 200° C. for 5 min, exhibiting laterally fragmented, highly corrugated fringe contrast consistent with nanometre-scale coherence and dense planar disorder.

FIG. 24 shows TEM images (with magnified regions) showing microstructural evolution during topotactic Li⁺/H⁺ exchange and subsequent annealing at 300° C. for 5 min, showing partial lateral coarsening but persistent intralayer disruption.

FIG. 25 shows TEM images (with magnified regions) showing microstructural evolution during topotactic Li⁺/H⁺ exchange and subsequent annealing at 575° C. for 15 h, displaying uniform layered fringes with d₀₀₃=0.47 nm indicative of extended coherent layered domains.

FIG. 26 shows galvanostatic charge-discharge profiles of layered cathodes spanning LiNiO₂ to lower Ni-content compositions (NM9: LiNi_{0.9}Mn_{0.1}O₂, NMC9055: LiNi_{0.9}Mn_{0.05}Co_{0.05}O₂, NMC811: LiNi_{0.8}Mn_{0.1}Co_{0.1}O₂, NMA81505: LiNi_{0.8}Mn_{0.15}Al_{0.05}O₂, and NMC622: LiNi_{0.6}Mn_{0.2}Co_{0.2}O₂) synthesized at 600° C. for 30 min, showing high reversible capacities and well-defined voltage features.

FIG. 27 shows charge-discharge profiles for the same materials synthesized under an even lower maturation condition (475° C. for 15 h), demonstrating that high-capacity layered behavior can be retained at substantially reduced thermal budgets.

FIG. 28 shows a processing map comparing synthesis temperature and dwell time for the oxyhydroxide-enabled route versus conventional hydroxide-based solid-state routes, highlighting that the steered pathway achieves layered cathodes at ~475-600 ° C., below the ≥700° C. regime commonly required for Ni-rich layered oxide.

FIG. 29 shows first-cycle electrochemistry of an O3-Mn-rich Na cathode (2.0-4.3 V vs. Na metal, 0.2 C) according to an aspect, showing 160 mAh/g first-discharge capacity and 93% first-cycle coulombic efficiency.

FIG. 30 shows neutron diffraction coupled with Rietveld refinement of a rapidly synthesized Mn-rich lithium-deficient layered (Li_{0.93}Ni_{0.07})^{3a}(Mn_{0.79}Ni_{0.21})^{3b}O₂ obtained at 350° C. for 30 min after oxyhydroxide preconditioning according to an aspect, consistent with the R3m layered phase.

FIG. 31 shows rate-dependent voltage profiles of the Mn-rich lithium-deficient layered cathode from 0.1 C to 10 C, demonstrating fast-charge operation (10 C charge corresponds to about 6 minutes).

FIG. 32 shows exemplary scanning electron microscope (SEM) images of oxyhydroxide precursor compositions according to various aspects of the present disclosure.

FIG. 33 shows x-ray diffraction (XRD) of an oxyhydroxide precursor according to an aspect of the disclosure.

### DETAILED DESCRIPTION

The challenges associated with solid-state synthesis of complex oxides is exemplified by high-energy nickel (Ni)-rich layered cathodes, materials indispensable for powering a diverse array of high performance frontiers, from electric aviation to autonomous robotics, yet notorious for their synthetic difficulty. Their reaction trajectory is readily intercepted by a disordered rocksalt phase that constitutes a metastable nonequilibrium intermediate. This phase acts as a persistent local minimum on the free-energy landscape. Although thermodynamically metastable relative to the global ground state (the layered product), they lie in close energetic proximity, resulting in a limited thermodynamic driving force to exit the trap. Consequently, synthesis is confined to a high-temperature regime: once the reaction trajectory enters the rock-salt basin, establishing the ordered framework requires overcoming a massive reconstructive barrier.

In view of structure, the origin of this barrier is immediately apparent. The rock-salt intermediate accommodates a fully disordered cation sublattice, whereas the layered phase demands long-range cation order and coherent interlayer registry. Converting one into the other therefore cannot proceed by a gentle, topology-preserving adjustment; it necessarily involves extensive atomic rearrangement and cooperative bond breaking and reformation within the close-packed oxygen framework. The solid-state reaction is thus constrained by an unfavorable combination of a small driving force and a large energy barrier, forcing synthesis into a high-temperature regime—not primarily to stabilize the layered phase, but to supply the activation needed to escape a metastable, structurally incompatible intermediate and rebuild ordered layering.

The present inventors have discovered a strategy to circumvent this energetic deadlock. By oxidatively transforming hydroxide precursors into oxyhydroxides, the energy landscape of accessible nonequilibrium states is reweighted, creating a bias toward configurations structurally homologous to the global ground state. This approach leverages topotaxy to preserve the crystallographic framework—crucial for structural fidelity—implemented via low-temperature thermodynamic control. This remodeling enables proton-lithium exchange below 200° C., granting access to a layered intermediate symmetry-matched to the final R3̅m layered phase. Accessing this intermediate effectively creates a thermodynamic “bypass” around the rock-salt basin.

To fully capitalize on this steered thermodynamic landscape for practical manufacturing, the focus shifts to optimizing the kinetic transport within micron-sized particles that are desired in commercial batteries. This involves reconciling a specific thermal window: the requisite proton-lithium exchange ideally occurs below 300° C. to preserve structural integrity. While this temperature lies below the melting point of LiOH (471° C.), rendering solid-state diffusion sluggish. This transport limitation places the system at a critical kinetic bifurcation, where the desired lithiation to the layered phase competes against a spontaneous decomposition to the rocksalt phase. To mitigate this kinetic hindrance, a lithium source infiltration strategy can be employed, but revealed that physical access alone is insufficient. Comparing infiltrated lithium sources, anhydrous LiOH drives the system toward the negative branch of the bifurcation: it fails to prevent surface Ni reduction, which acts as a kinetic gatekeeper blocking inward diffusion. In distinct contrast, LiOH monohydrate secures the positive pathway. Its in situ vapor generation actively suppresses surface reduction and facilitates Li⁺/H⁺ exchange, thereby ensuring uniform phase transformation throughout the particle.

By kinetically biasing the topotactic pathway, phase formation is decoupled from structural ordering. Consequently, mild annealing (e.g., at 475° C.) suffices to drive local defect reorganization rather than the energy-intensive process of phase nucleation. This framework reduces the synthesis temperature by >250° C., establishing thermodynamic steering as a general strategy for resolving kinetic bottlenecks in solid-state synthesis. A significant improvement is therefore provided by the present disclosure.

Accordingly, an aspect of the present disclosure is a method for the manufacture of a cathode active material. The present inventors have discovered that use of an oxidized precursor can provide certain advantages. Thus the method comprises oxidizing a transition metal hydroxide under conditions effective to provide a corresponding transition metal oxyhydroxide.

The transition metal hydroxide can be of the formula TM(OH)₂, wherein TM is a transition metal. As used herein, the term “transition metal” refers to an element belonging to Groups 3-12 of the Periodic Table of the Elements. Representative transition metals include, without limitation, scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg), or combinations thereof. In some aspects, TM of the formula TM(OH)₂ can comprise a transition metal and optionally one or more dopants, where the transition metal and the one or more dopants may be selected from Ni, Co, Mn, Fe, Al, Mg, Ca, Sc, Ti, V, Cr, Cu, Zn, Ga, Ge, Y, Zr, Nb, Mo, Ru, Rh, Sn, Sb, Ir, Bi, Si, B Ce, La Ta, W, or a combination thereof. In some aspects, the transition metal and when present, any metal dopants, are selected from metals which are useful as cathode active materials. In some aspects, the transition metal can comprise Ni, Mn, Co, Al, Mg. As used herein, the transition-metal component may further include aluminum (Al), magnesium (Mg) as Mg/Al-containing compositions (e.g., Ni—Mn—Co—Al or Ni—Mn—Co—Mg oxides) are commonly employed in layered cathode materials. In some aspects, the transition metal can comprise Ni, Co, Mn, Al, or a combination thereof. In a specific aspect, the transition metal hydroxide can comprise Ni (Ni(OH₂)), Co (Co(OH)₂), Mn (Mn(OH)₂), Al (Al(OH)₃)), or a combination thereof.

Oxidizing the transition metal oxide can comprise contacting the transition metal hydroxide with an oxidant under suitable conditions. The oxidant is not particularly limited, and can include, for example, persulfates such as sodium persulfate (Na₂S₂O₈) or potassium persulfate (K₂S₂O₈); hypohalites, including sodium hypochlorite (NaClO) provided as a powder, concentrated aqueous bleach, or buffered hypochlorite solutions; and strong gaseous or dissolved oxidants, such as ozone (O3), oxygen plasma, or ozone-enriched oxygen streams. Additional exemplary oxidants include peroxides (e.g., hydrogen peroxide, peracetic acid), periodates, permanganates, and other high-valent oxo-anions that can effect oxidative conversion.

The oxidation may be carried out in aqueous, mixed aqueous-organic, or non-aqueous media, and under neutral, acidic, or basic conditions, provided that the conditions maintain do not adversely affect the reaction of transition metal hydroxide to the transition metal oxyhydroxide. In some aspects, oxidation can be conducted under basic conditions, which, without wishing to be bound by theory, are believed to promote hydroxyl retention while supporting topotactic formation of the oxyhydroxide phase. Temperature, oxidant concentration, and reaction time can be adjusted to control the degree of oxidation (δ) and to tailor the resulting structural lability that enables subsequent Li⁺/H⁺ exchange. The foregoing oxidants may be used singly or in combination, and the selection may be optimized based on, for example, precursor composition, particle size, or desired intermediate properties. Exemplary oxidation conditions are further described in the working examples below.

The transition metal oxyhydroxide provided by the oxidation can be of the formula TMOOH_{2-δ}, wherein TM is a transition metal, for example comprising Ni, Co, Mn, Al, or a combination thereof, and wherein δ is 0<δ≤1, for example 0.1<δ≤0.9, or 0.2<δ≤0.8.

In some aspects, the transition metal oxyhydroxide can comprise Ni; or Ni and Mn; or Ni, Mn, and Co. For example, the transition metal oxyhydroxide can be of the formula Ni_{0.6}Mn_{0.2}Co_{0.2}OOH_{2-δ}, Ni_{0.8}Mn_{0.1}Co_{0.1}OOH_{2-δ}, or Ni_{0.9}Mn_{0.1}Co_{0.1}OOH_{2-δ}; Ni_{0.8}Mn_{0.15}Al_{0.05}OOH_{2-δ}; or NiOOH_{2-δ}. In some aspects, the transition metal oxyhydroxide can be in the form of particles. The particles may be spherical, but particle morphology is not particularly limited and other shapes are contemplated here. The secondary particles comprising the transition metal oxyhydroxide can have any average particle size, for example, of 3 to 20 micrometers. The transition metal oxyhydroxide can exhibit a layered crystallographic stacking topology characterized by preserved 00l reflections in X-ray diffraction. Characteristics of the transition metal oxyhydroxide intermediate are further described in the working examples below.

Advantageously, the oxyhydroxide precursor material described herein exhibits a set of distinguishing structural and morphological features that differ markedly from conventional hydroxide precursors used in industrial cathode manufacturing. The secondary particles maintain a micron-scale spherical morphology (for example, having an average particle size of 1 to 20 micrometers (μm)), which is advantageous for electrode processing and high volumetric energy density. The material can further exhibit nanoscale crystalline domains (for example, having an average domain size of 10 to 30 nanometers (nm)), significantly smaller than those of standard precursors, a feature that is believed to facilitate rapid alkali metal ion (e.g., Li⁺) insertion during calcination. The oxyhydroxide framework further displays low crystallinity and pronounced anisotropy, retaining coherent stacking along the c-axis while showing substantially reduced structural coherence within the ab plane, consistent with the anisotropic domain morphology and stacking disorder observed in TEM and diffraction analyses. Within the slabs, the in-plane atomic arrangement lacks long-range periodicity, even as adjacent layers remain registrationally aligned, resulting in a high degree of structural lability. Additionally, the material contains an elevated density of stacking faults and extended planar defects, distinctly exceeding those present in pristine hydroxide precursors. As a compositional family, these oxyhydroxides support flexible transition-metal ratios provided overall charge balance is maintained, and the specific defect-rich, anisotropic, small-domain compositions provided herein have not been reported for cathode production. Collectively, these attributes including smaller domain size, greater anisotropy, and higher defect density define a unique precursor class that enables the topotactic, low-temperature reaction pathway central to the disclosed manufacturing process. A significant advantage in cathode active precursor materials is therefore provided by the present disclosure.

The method further comprises contacting the transition metal oxyhydroxide with an alkali metal source. The alkali metal source can be an alkali metal salt and is not particularly restricted. In an aspect, the alkali metal salt can be an alkali metal hydroxide, though other salts such as carbonates, and the like are also contemplated by the present disclosure. The alkali metal of the alkali metal source can be potassium (K), lithium (Li), sodium (Na), or a combination thereof. In some aspects the alkali metal source can be a hydrated alkali metal source, for example NaOH·H₂O or LiOH·H₂O.

The contacting can be under conditions effective to form a oxyhydroxide intermediate having alkali metal cations inserted therein. In an aspect, the contacting can be at a temperature of 300° C. or less. In some aspects, the contacting can comprise mixing the transition metal oxyhydroxide with the alkali metal source, e.g., the alkali metal salt or hydrated form thereof. The mixing can be by any suitable means, for example manual mixing or mechanical mixing. The mixture can be immersed into an aqueous solution, for example a basic (e.g., pH>7) aqueous solution. The transition metal oxide and the alkali metal can be present in quantities sufficient to provide an overall alkali metal: transition metal ratio of 0.9:1.1 to 1.0 to 1.1, or 0.95:1.1 to 1:1.05, or 1:1.05. The alkali metal/transition metal slurry can be heated to a temperature effective to evaporate water, and the dried material can be collected.

Contacting the transition metal oxyhydroxide with an alkali metal source can effect a topotactic alkali metal/hydrogen ion exchange that preserves a layered crystallographic stacking of the transition metal oxyhydroxide.

The method further comprises heat treating the oxyhydroxide intermediate at a temperature of 400 to 650° C. to form the cathode active material. In an aspect, heat treating the oxyhydroxide intermediate can be for a time of 12 hours or less, thereby providing a process that uses a combination of reduced temperature and time compared to known processes.

The resulting cathode active material obtained from the heat treatment (also referred to herein as calcination) can be a layered cathode active material or a spinel cathode active material. In some aspects, the method described herein can provide a layered cathode active material having an alkali metal/transition metal antisite mixing of less than or equal to 3%. A cathode active material made by the present method represents another aspect of the present disclosure.

This disclosure is further illustrated by the following examples, which are non-limiting.

### EXAMPLES

### Structural Origin of the Kinetic Trap in Conventional Synthesis

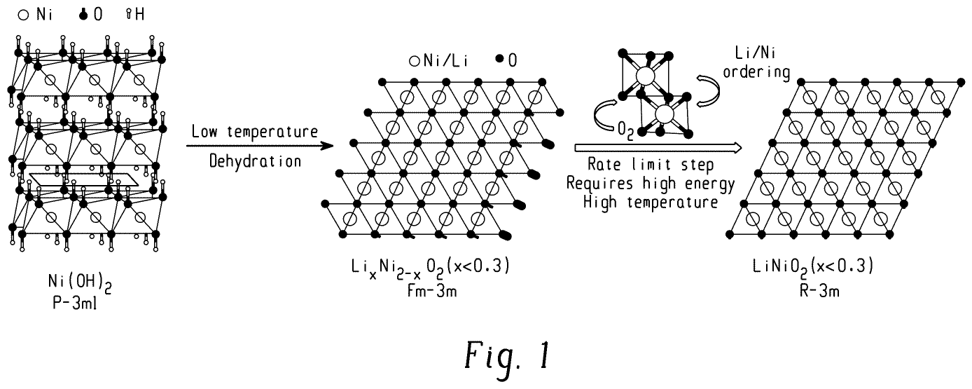

To elucidate the physical origin of the synthetic bottleneck inherent to Ni-rich layered cathodes, stoichiometric LiNiO₂ (LNO) was selected as the primary model system. Representing the compositional limit of this material class, LNO functions as the representative model system, amplifying the intrinsic structural instabilities and kinetic constraints that define the synthesis of ultra-high Ni layered oxides. The crystallographic trajectory of LNO was conceptualized along the conventional solid-state route as illustrated in FIG. 1. The thermal dehydration of the Ni(OH)₂ (P3̅m1) triggers a drastic collapse of the interslab distance along the crystallographic c-axis. This topological discontinuity involves extensive oxygen sublattice shearing and stochastic cation migration, driving the system into a cubic disordered rock-salt intermediate (Fm^{3̅m}, c-LiₓNi₂₋ₓO₂).

Significantly, this synthetic bottleneck is not unique to the Ni-rich layered oxides, but reflects a broader challenge across alkali metal layered oxides (Li⁺, Na⁺, and K⁺ based systems): the kinetic trapping of the system in persistent metastable intermediates. A salient example is found in the pursuit of O3-type sodium/potassium layered cathodes. Due to their high alkali occupancy, these materials are critical for practical manufacturing as they serve as sufficient ion reservoirs, obviating the need for complex pre-metalation steps required by cation-deficient P2/P3 counterparts. However, while the O3 structure is the thermodynamic ground state for these stoichiometric compositions, their synthesis is frequently obstructed by kinetically persistent P-type intermediates. The transformation from these precursors to the target O3 phase requires cooperative TMO₂ slab gliding to alter the oxygen stacking sequence, a process with a high energy barrier. Consequently, undesired polymorphs often survive as parasitic intergrowths. Similarly, in the LNO system, the disordered rock-salt phase acts as the analogous kinetic trap. By demonstrating how to navigate this kinetic bottleneck through thermodynamic steering in the representative LNO system, we establish a conceptual blueprint for guiding the rational synthesis of other types of cathode materials.

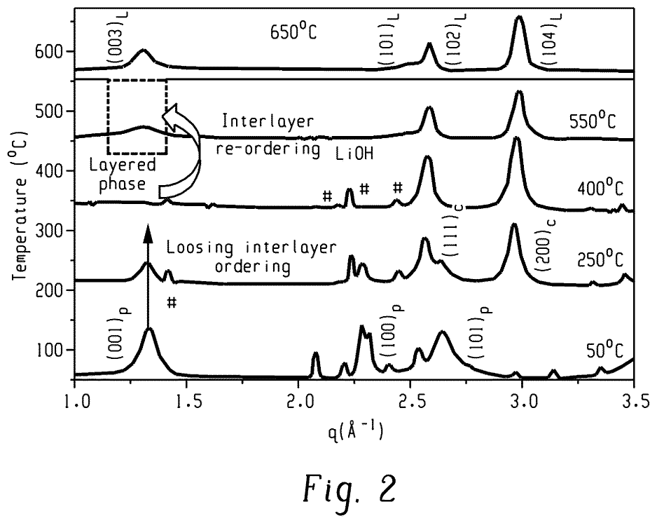

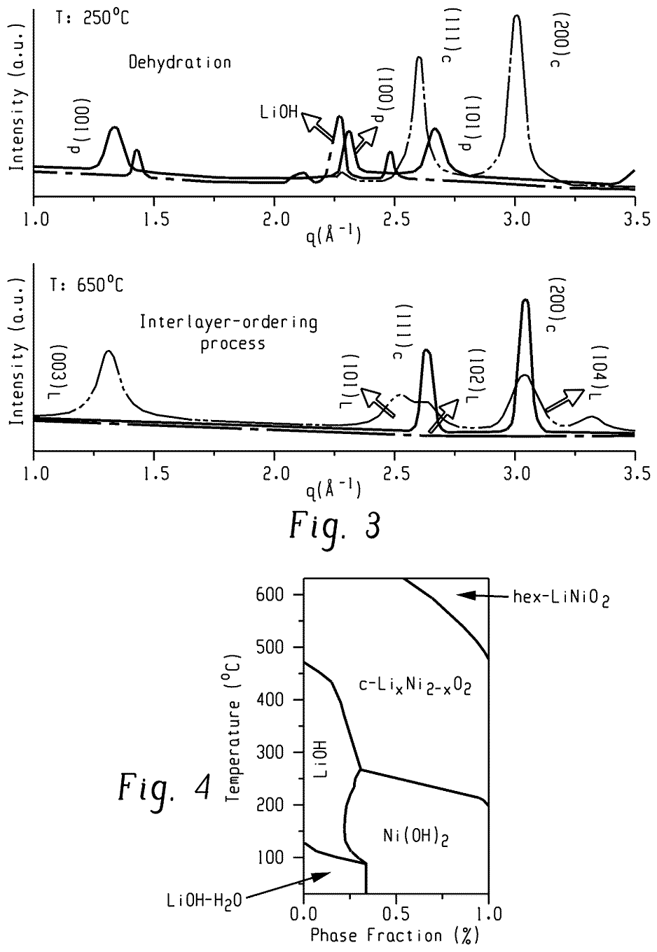

The existence of this kinetic trapping of the rocksalt phase was experimentally validated using temperature-resolved in situ synchrotron X-ray diffraction on the LNO system (FIG. 2). Consistent with the trap hypothesis, the heating of the conventional precursor mixture reveals a rapid loss of layered periodicity. Detailed Rietveld refinement profiles (FIG. 3) capture distinct snapshots of this transformation: at low temperatures (~250° C.), the characteristic precursor reflections (e.g., (001)_{P}) start to vanish, replaced by the broad peaks corresponding to the disordered rock-salt phase. It is only at elevated temperatures that the signature (003)_{L} layered reflection begins to emerge from the background; notably, its broad peak and sluggish intensity evolution signal that the layered phase initiates via a kinetically hindered nucleation process, marking the difficult onset of cation ordering. The severity of this intermediate stage is rigorously quantified in the phase evolution diagram (FIG. 4). This diagram reveals that the disordered rock-salt phase does not merely appear as a transient blip; rather, it dominates the phase fraction over a wide thermal window, confirming its persistence as a robust kinetic intermediate that effectively interrupts the direct formation of the layered structure.

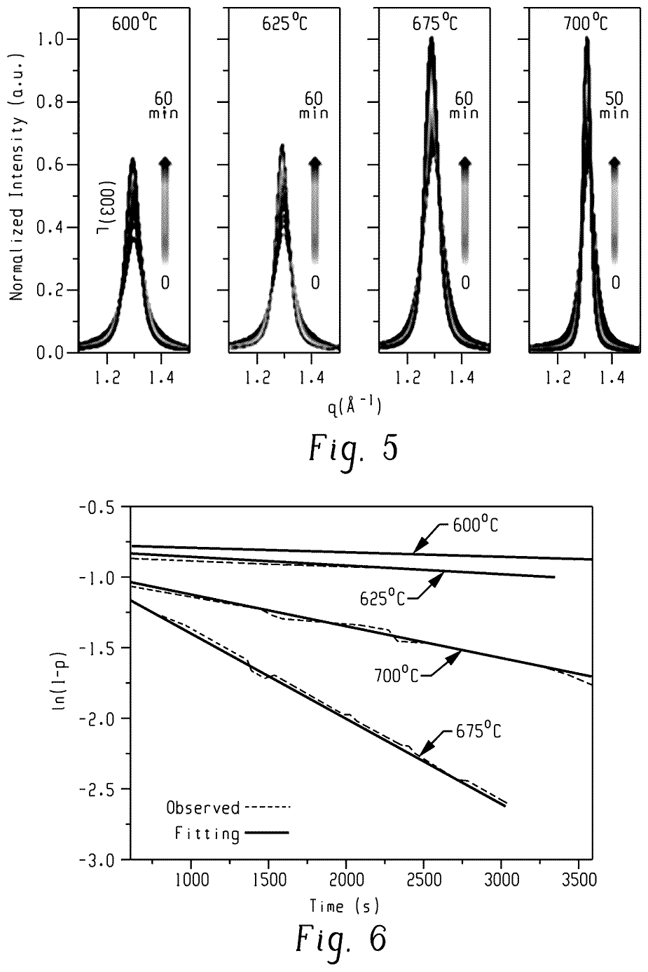

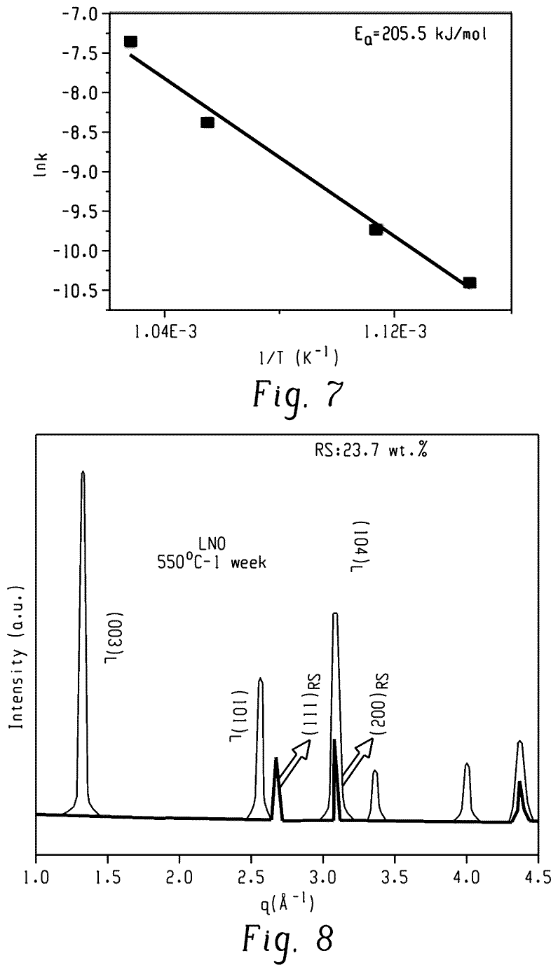

To measure the energy required to break this deadlock, the kinetics of layered phase formation were captured via Rietveld refinement of the time-resolved in situ synchrotron XRD recorded during isothermal holding experiments (FIG. 5-7). The temporal evolution of the refined layered phase fraction, defined as the degree of transformation α, reveals a linear relationship between ln(1-α) and time (FIG. 6), indicating that the ordering transformation follows first-order kinetics. From the extracted rate constants (k) at varying temperatures, we calculated an apparent Arrhenius activation energy of 205 kJ mol⁻¹ (FIG. 7). This substantial energy barrier quantitatively corroborates that the conventional solid-state synthesis of LNO is fundamentally limited by the energetic cost of driving the system out of the rock-salt basin.

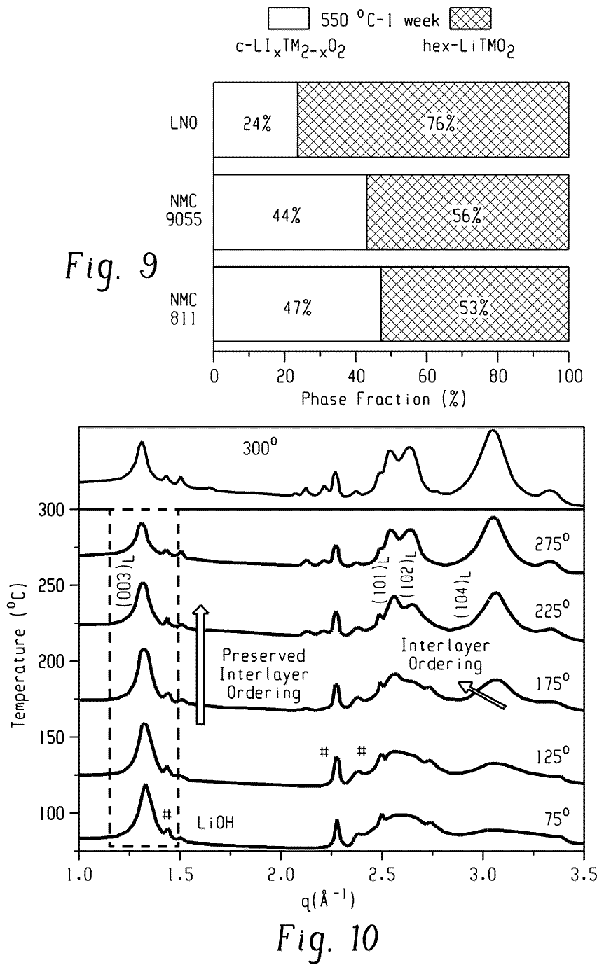

The persistence of this kinetic trap is further highlighted by its resistance to extended thermal treatment. As shown in the Rietveld refinement in FIG. 8, even after a prolonged annealing of 1 week at 550° C., the LNO lattice fails to fully re-order, retaining a substantial 24% in weight fraction of the disordered rock-salt phase. This confirms that at moderate temperatures, the system is effectively “frozen” in the local minimum; the ordering kinetics are so sluggish that the transformation becomes unfeasible within any practical manufacturing timeframe, proving that time is a poor substitute for thermal activation. Furthermore, this kinetic bottleneck is not unique to pure LNO but appears to be a universal feature of high-Ni chemistries—and counter-intuitively, potentially more severe in Co/Mn-substituted systems under these solid-state conditions. As summarized in FIG. 9, decreasing the Ni content from pure LNO to NMC9055 (LiNi_{0.9}Mn_{0.05}Co_{0.05}O₂) and NMC811 (LiNi_{0.8}Mn_{0.1}Co_{0.1}O₂) results in an increase in the retained rock-salt weight fraction to 44% and 47%, respectively. This compositional trend implies that while Co and Mn are often considered as stabilizers in the final layered structure, they impose a severe kinetic penalty for the layered phase formation, suggesting that the activation energy barrier for the rock-salt-to-layered reconstruction in these mixed systems could be even higher than the 205 kJ mol⁻¹ identified for pure LNO. This “compositional stubbornness” underscores the urgent need for a new thermodynamic pathway that bypasses this reconstruction entirely, rather than merely optimizing calcination protocols.

### Thermodynamic Steering Accesses a Layered Nonequilibrium Intermediate

To circumvent the structural deadlock of the conventional route, where reactions are readily intercepted by a rock-salt kinetic trap, thermodynamic steering was implemented to access a layered nonequilibrium intermediate at low temperature. Although layered-to-layered transformations have been observed in layered oxides with lower Ni content, which is often stabilized by higher Co/Mn fractions, the dynamics that determine when this pathway is accessible, and why it so often fails in Ni-rich systems, have remained unclear. The present inventors have shown that success hinges on a decisive kinetic bifurcation between topotactic Li⁺/H⁺ exchange and precursor decomposition to rock salt.

The present strategy relies on oxidative preconditioning of the precursor. The stable hydroxide TM(OH)₂ was converted into a metastable oxyhydroxide TMOOH_{2-δ}, thereby reweighting the set of accessible nonequilibrium states. Oxidation produces a strongly anisotropic disordering, as shown in FIG. 10, which suppresses in-plane coherence (weakening hk0 features) while preserving the layered stacking periodicity along stacking direction (retaining 00l reflections). The resulting oxyhydroxide therefore remains topologically layered but becomes structurally labile within the slabs, enabling Li⁺/H⁺ exchange without first collapsing into a cubic intermediate.

The steered reaction trajectory is directly visualized in NMC811. Temperature-resolved in situ synchrotron XRD (FIG. 10) shows that the (003)_{L} reflection persists throughout the low-temperature evolution. Strikingly, the characteristic (104) reflection emerges at ~175° C. (orange arrow), indicating the formation of a predominantly layered lithiated oxyhydroxide nonequilibrium intermediate that is indexable by average R^{3̅}m symmetry, rather than an intervening rock-salt-dominated cubic stage. These signatures point to a topotactic exchange process in which lithiation progressively restores intralayer coherence while preserving stacking registry, thereby activating a layered-to-layered transformation that successfully bypasses the rock-salt basin (FIG. 11).

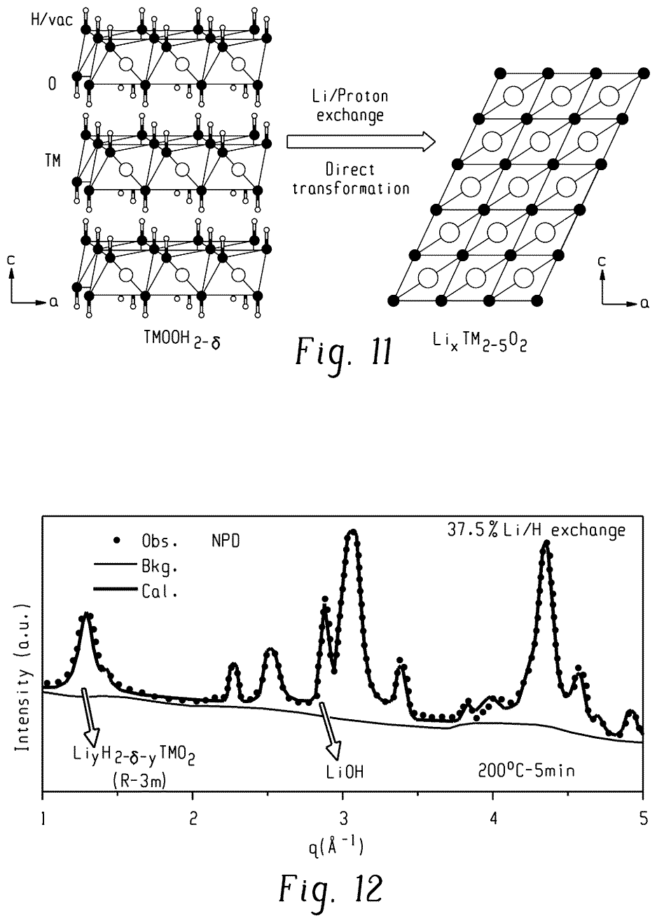

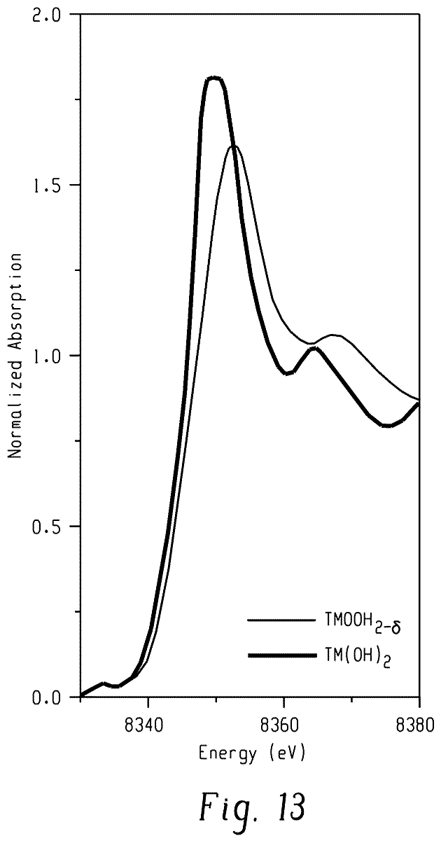

The identity of this intermediate is corroborated by complementary neutron powder diffraction and X-ray near edge absorption spectroscopy. NPD coupled with Rietveld refinement (FIG. 12) identifies a lithiated layered oxyhydroxide phase. Ni K-edge XANES, comparing the precursor before and after oxidative preconditioning, confirms the conversion of TM(OH)₂ to TMOOH_{2-δ}through an increase in the nickel oxidation state (FIG. 13). Together, these measurements establish that thermodynamic steering originates from an oxyhydroxide precursor and accesses a distinct layered nonequilibrium intermediate, rather than an intervening cubic disordered rock-salt phase.

Access to this layered intermediate, however, exposes a kinetic bifurcation in which two pathways compete. Below the melting point of LiOH, Li delivery is intrinsically transport-limited and the reaction is dominated by short-range interfacial diffusion. Under these conditions, Li_{y}H_{2-δ-y}TMO₂ can either (i) undergo continued Li⁺/H⁺ exchange that progressively stabilizes the layered framework and permits further topotactic evolution, or (ii) if Li supply is insufficient, remain only partially exchanged and structurally fragile, leading to decomposition into rock-salt products. The measured phase fractions therefore reflect the kinetic outcome of this competition between exchange-driven layered stabilization and decomposition to rock salt, with transport limitations shifting the balance toward the latter.

To rigorously disentangle phase stability from diffusion-length effects, a series of nanometric oxyhydroxide precursors were synthesized with metal compositions spanning from Ni60 to Ni100 (corresponding to NMC622-LNO targets). The parent hydroxides were ball milled to comparable nanometric dimensions prior to oxidation, thereby normalizing the diffusion path lengths across the series. Tracking the reaction trajectories via in situ XRD reveals that while the layered-to-layered transformation is accessible for all compositions, it is invariably accompanied by competitive decomposition into the rocksalt phase. Quantitative analysis of the phase fractions for the XRD patterns collected at 300° C. exposed a stark compositional dependence: despite minimized diffusion lengths, the fraction of decomposition product (rocksalt phase) rises sharply as the the decreasing of Co/Mn contents, reaching ~65% for the pure Ni100 precursor. This confirms that the yield of the layered phase is not solely dictated by diffusion kinetics but is fundamentally limited by the intrinsic thermodynamic instability of the high-Ni lithiated oxyhydroxide intermediate, which is determined by the composition of the precursor. As the Ni content increases, the driving force for decomposition becomes progressively stronger, rendering purely thermodynamic control insufficient for ultra-high Ni chemistries. Consequently, effective kinetic control is required to suppress this decomposition, a challenge addressed in the following section by demonstrating a vapor-mediated, low-temperature Li⁺/H⁺ exchange strategy that preferentially guides the reaction toward the layered phase.

### Overcoming Transport Limitations in Micron-Sized Particles Via Vapor-Mediated Li⁺/H⁺ Exchange

Implementing the above pathway in micron-sized secondary particles, which is essential for maximizing volumetric energy density and mitigating interfacial side reactions, confronts a more severe geometric bottleneck. In this regime, the diffusion timescale scales as t ∝L², and with the Li⁺/H⁺ exchange temperature restricted well below the melting point of LiOH (471° C.), transport is confined to sluggish solid-state interfaces. To decouple geometric access from these transport limitations, a solution-infiltration strategy was employed to pre-distribute the lithium precursor throughout the tortuous porous architecture. The role of hydration could be isolated by comparing two processing routes: a vacuum-dried (anhydrous) control and an ambient-dried (hydrated) route where LiOH·H₂O retains crystal water to enable in situ vapor generation.

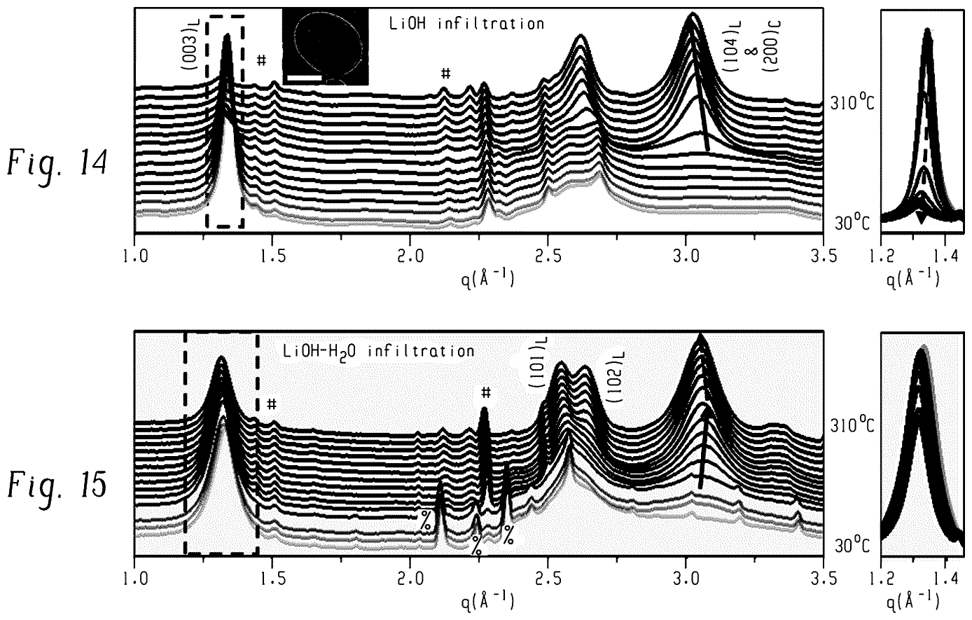

The divergence in reaction trajectories is captured by in situ synchrotron XRD. In the anhydrous LiOH infiltration control (FIG. 14), the reaction trajectory is dominated by thermal decomposition. While traces of the layered phase appear initially, the characteristic (003)_{L} reflection rapidly decreases in intensity as the temperature increases. This rapid decay, accompanied by the simultaneous rise of rock-salt reflections, confirms that the intermediate decomposes faster than the Li⁺/H⁺ exchange can proceed. In stark contrast, the LiOH·H ₂O infiltration route (FIG. 15) effectively counters this instability: the (003)_{L} reflection exhibits a significantly suppressed decay rate compared to the anhydrous control. This sustained intensity signifies that the in situ generated vapor facilitates Li/H exchange, allowing the lithiation kinetics to effectively outcompete the decomposition pathway.

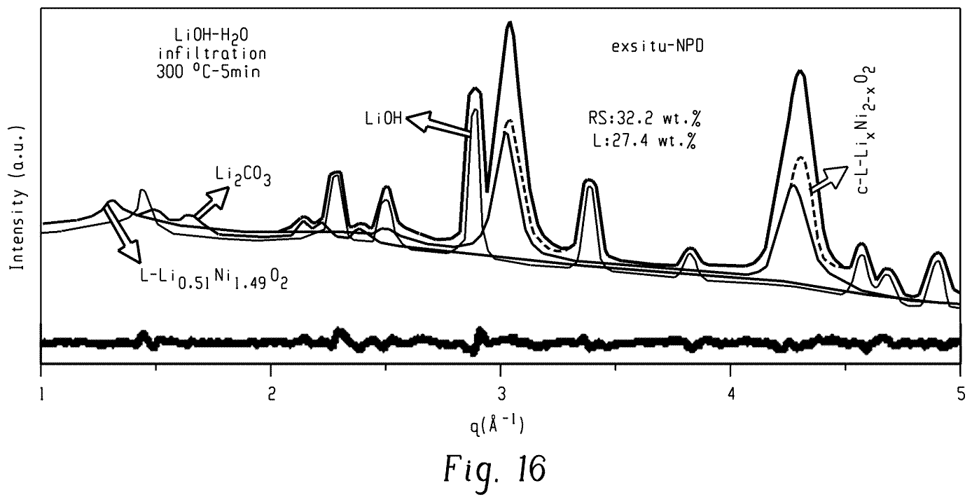

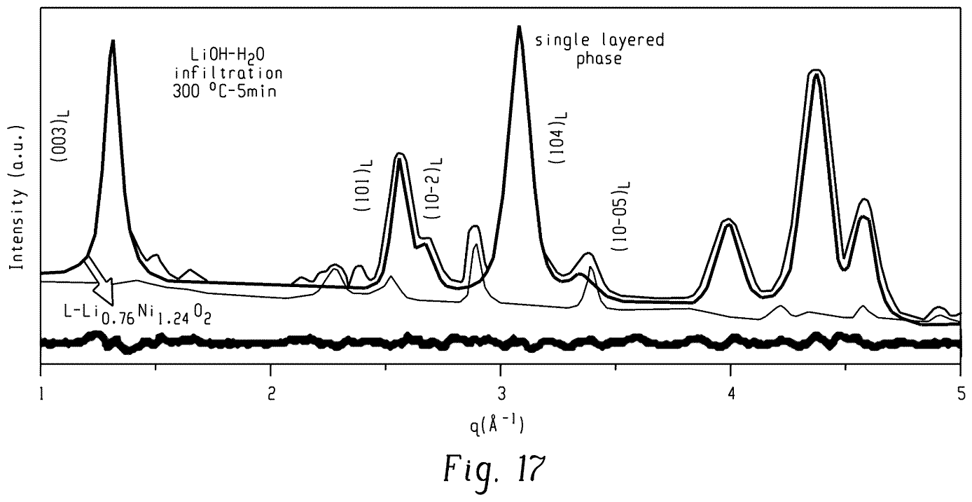

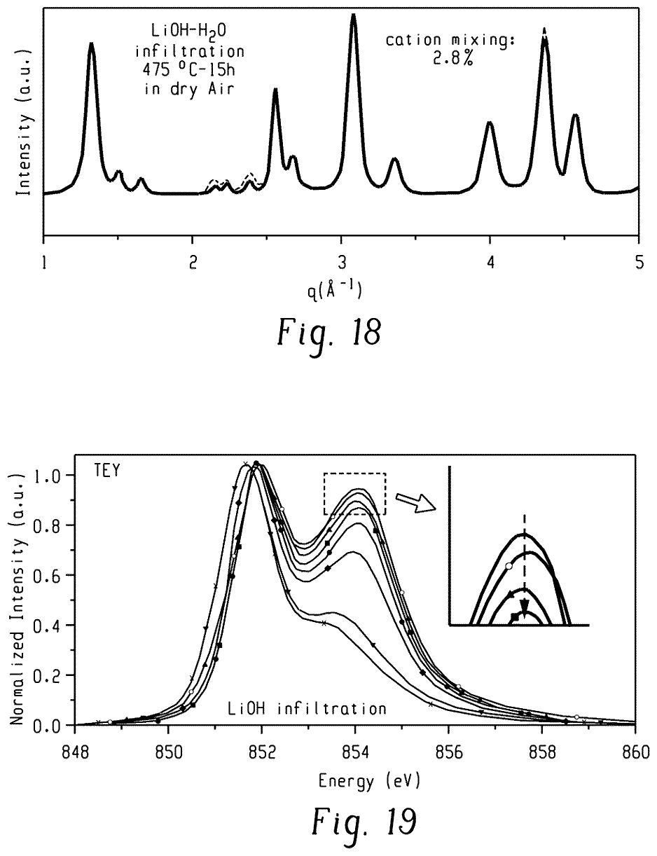

Ex situ NPD coupled with Rietveld refinement quantifies this phase selection at the critical 300° C. window. The LiOH infiltrated sample contains substantial rock-salt phase (32.2 wt. % RS and 27.4 wt. % layered phase) resulting from decomposition (FIG. 16), whereas the LiOH·H₂O infiltrated sample is dominated by a single layered phase (FIG. 17). Subsequent annealing at 475° C. for 15 hours, the LiOH·H₂O infiltrated evolves into highly ordered layered phase with low Li/Ni antisite mixing (2.8%, FIG. 18).

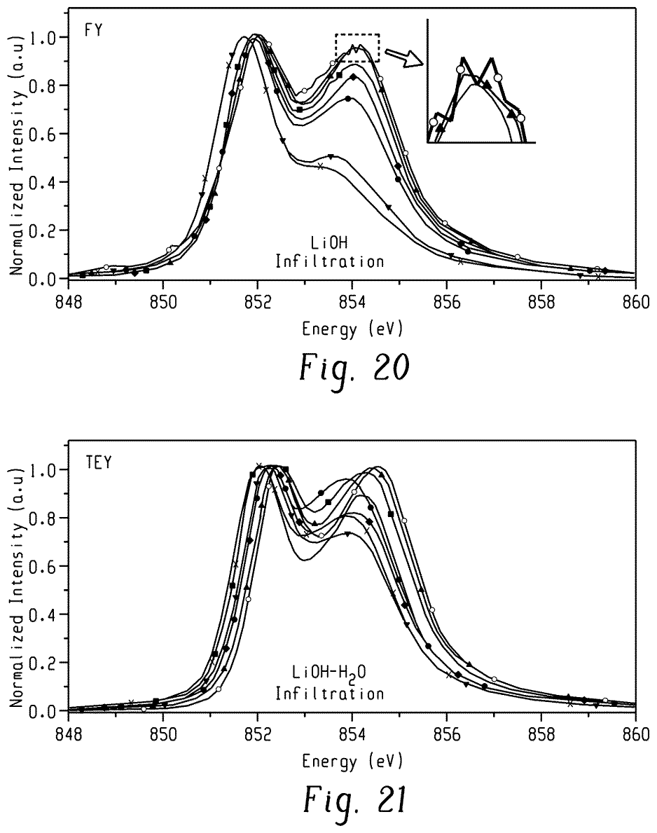

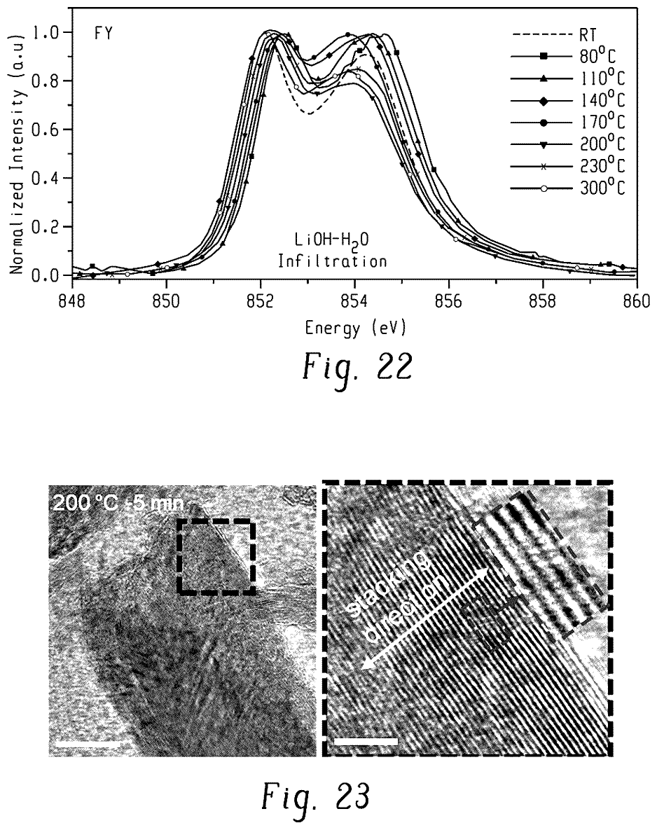

To elucidate the transport mechanism, depth-resolved soft XAS was utilized. The LiOH infiltrated route shows a discrepancy between surface-sensitive TEY and bulk-sensitive FY spectra (FIGS. 19 and 20), revealing preferential Ni reduction near the surface at low temperatures (80-140° C.). These results suggest that surface degradation acts as a kinetic passivation layer, blocking inward Li transport and intercepting the bulk reaction. Conversely, the LiOH·H₂O infiltrated route displays congruent surface-bulk evolution (FIGS. 21 and 22), indicating that in situ water vapor suppresses surface reduction and facilitates Li⁺/H⁺ exchange.

This mechanism is visually corroborated by 3D Ni K-edge TXM-XANES mapping. In the solid mixing baseline (pristine Ni(OH)₂), lithiation at 300° C. is strictly confined to the particle periphery, as solid LiOH lacks the mobility to diffuse into the bulk. Consequently, even after 475° C. sintering, the particle exhibits an overall low oxidation state. Moving to LiOH infiltration, improved physical lithium access is evident at 300° C., where localized high-valence regions, indicating successful Li insertion, appear deep within the particle interior. However, this inward transport is kinetically intercepted by decomposition; despite these internal contact points, the bulk remains dominated by a low-valence state. This stands in stark contrast to the LiOH·H₂O infiltration route, which achieves widespread high-valence states at 300° C., displaying a core-shell structure that evolves into a more uniform high-valence distribution after 475° C. annealing. This macroscopic uniformity confirms that the vapor-mediated Li⁺/H⁺ exchange effectively selects the layered phase formation.

Annealing intralayer order and planar faults at moderate temperature

Having established that thermodynamic steering can access a layered lithiated oxyhydroxide intermediate, and that transport control in micron-size secondary particles is required to keep the reaction on the Li+/H+ exchange branch rather than decomposing to rock salt, what thermal budget is required after the layered phase is kinetically secured is needed to develop the long-range order and reduced defect density needed for desired electrochemical performance.

A defining structural feature of the oxidized oxyhydroxide precursor is its strongly anisotropic coherence. In diffraction, sharp 00l reflections coexist with markedly attenuated reflections carrying substantial in-plane components (hk0), indicating that the stacking periodicity along c direction is largely retained, whereas intralayer registry within the transition-metal-oxygen slabs is substantially disrupted by oxidation. Because the subsequent Li⁺/H⁺ exchange proceeds topotactically, the low-temperature lithiated product is expected to inherit this anisotropic coherence rather than erase it through a reconstructive rearrangement.

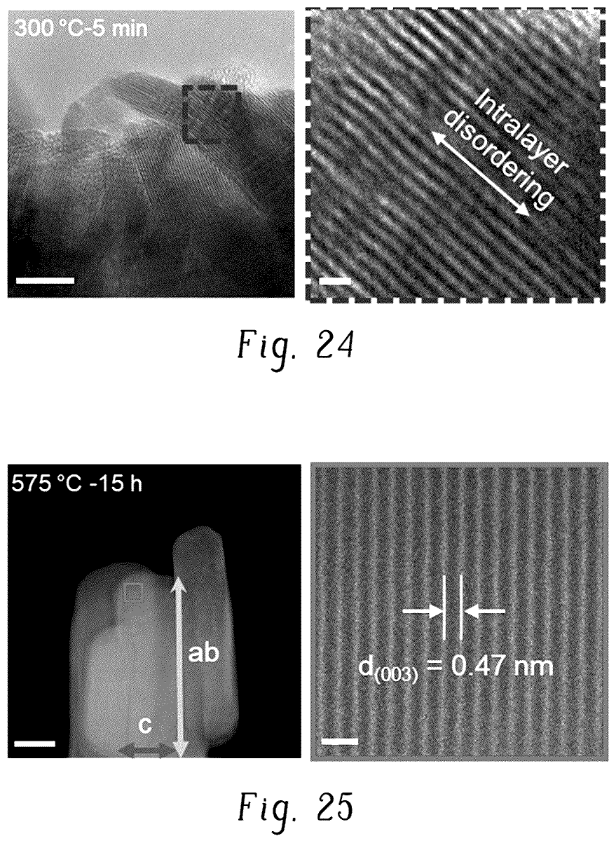

This crystallographic “memory” is directly reflected in TEM imaging following Li⁺/H⁺ exchange. After a 200° C. hold for 5 min, lattice-fringe contrast is highly corrugated and exhibits preferential coherence along the stacking direction, consistent with a layered topology that is established locally but laterally partitioned by stacking disorder and very short in-plane coherent lengths (FIG. 23). Raising the temperature to 300° C. for 5 min modifies the microstructural signature: fringes become more laterally extended, yet substantial disruption within the slabs persists (FIG. 24). This evolution indicates that early-stage exchange and short-range cation rearrangements begin to alleviate the most severe stacking irregularities and translational variants but remain insufficient to restore extended intralayer order. Only after prolonged annealing at moderate temperature (e.g., 575° C. for 15 h) do well-defined layered fringes with the expected interlayer spacing (d₀₀₃=0.47 nm) dominate (FIG. 25), evidencing a transition from a defect-rich lamellar assembly to a crystallographically coherent layered oxide with substantially improved three-dimensional registry.

To quantify this evolution beyond qualitative TEM imaging, direction-dependent coherent domain sizes were reconstructed from anisotropic line broadening in diffraction, parameterized as D(\hat{n}). The resulting coherent domain morphology maps reveal a clear progression. At 200° C., coherent dimensions are confined to the nanometre scale and are strongly anisotropic, consistent with domains that inherit stacking registry but lack extended lateral coherence. At 300° C., the direction-dependent coherent-domain size distribution broadens and smooths, indicating the onset of lateral coarsening and partial healing of the most severe stacking disorder. Only after the moderate temperature anneal does the reconstructed D(\hat{n}) morphology expand markedly, with the strongest increase occurring within the ab plane and a more modest extension along c. The change is consistent with growth of in-plane coherent domains and progressive annealing of stacking disorder, transforming a topology-preserved but microstructurally immature framework into a more highly ordered layered domain network.

Synchrotron XRD coupled with Rietveld refinement corroborates that this thermal maturation corresponds to genuine crystallographic ordering rather than mere grain growth. A representative refinement after annealing yields a low Li/Ni antisite mixing (Ni²⁺ in the 3b site: 2.7%), confirming that moderate-temperature treatment is sufficient to recover a well-ordered layered lattice once the reaction has been kinetically directed away from rock-salt decomposition. Together, these results resolve the role of the post-annealing in the steered synthesis: the low-temperature step determines phase trajectory (layered vs rock salt), whereas the subsequent moderate-temperature hold primarily drives stacking-fault annealing and intralayer ordering within an already layered framework, completing the structural requirements for electrochemically active layered cathodes.

### Low-Temperature Steered Synthesis Yields Electrochemically Functional Ni-Rich Cathodes Across Composition and Scale

With the phase trajectory redirected away from the rock-salt trap and the layered framework kinetically secured, the remaining thermal budget can be used for defect healing rather than phase transformation. This separation of “phase selection” from “defect healing” enables a unified low-temperature protocol that produces electrochemically functional Ni-rich layered cathodes across a broad composition range.

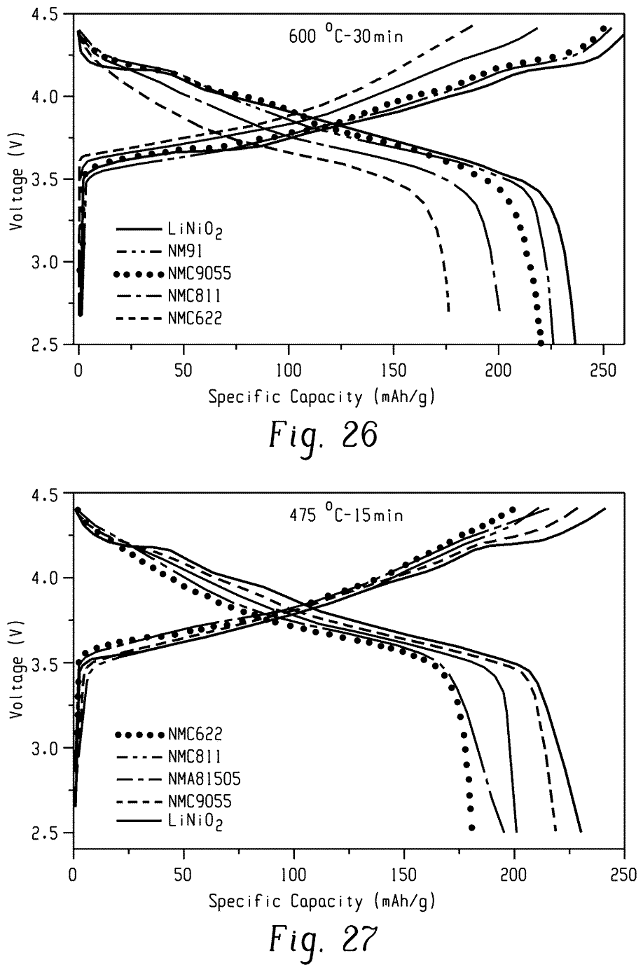

Electrochemical testing confirms that materials synthesized under the same low-temperature window deliver the characteristic voltage profiles of Ni-rich layered oxides with high reversible capacities (FIGS. 26 and 27). Notably, rapid calcination at 600° C. for 30 min already yields high-capacity behavior for compositions spanning LNO to Co/Mn-containing NMCs, underscoring that 600° C. is a genuinely low-temperature condition in the context of layered-cathode manufacturing, where conventional hydroxide-based solid-state routes typically require ≥700° C. to overcome the rock-salt detour. Even more strikingly, after the steered pathway establishes the layered framework, 475° C. annealing can still produce high-capacity cathodes (FIG. 27), consistent with a regime where moderate heat primarily reduces defect density and improves crystallographic coherency rather than driving reconstructive phase formation.

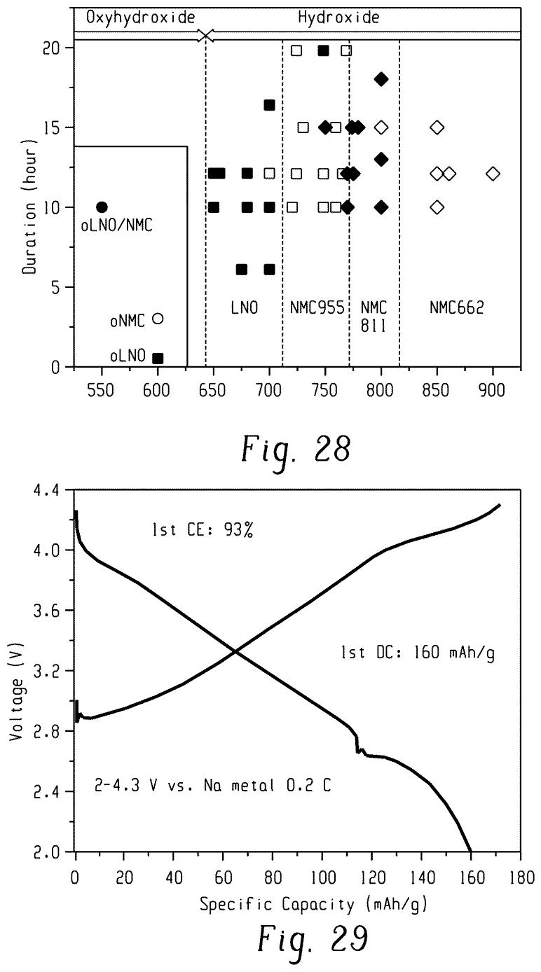

This low-temperature processing also sustains stable cycling at practical rates. Under 1 C operation within 2.5-4.4 V, the steered-synthesis cathodes maintain stable capacities over extended cycling, indicating that the reduced-temperature route does not compromise electrochemical durability. The process advantage is summarized by the temperature-time map (FIG. 28), which shows that the oxyhydroxide-enabled pathway compresses the synthesis window into ~475-600° C. at substantially shorter durations compared with the high-temperature envelope commonly required for hydroxide-derived routes. Finally, the approach is compatible with scale-relevant manufacturing: kilogram-scale precursor preparation, hundreds-of-grams product yield, and stable cycling in a 1 Ah NMC9055-SiGr pouch cell together demonstrate that the strategy translates beyond small-batch laboratory synthesis.

### Chemistry-Agnostic Generality of Low-Temperature Cathode Synthesis Enabled by Tailoring Nonequilibrium Intermediates

The central constraint in low-temperature solid-state synthesis is often not the identity of the equilibrium ground state, but whether the reaction trajectory is intercepted by structurally incompatible nonequilibrium basins that are easy to enter yet difficult to escape. The key implication of thermodynamic steering is therefore general: by designing the nonequilibrium intermediate to be structurally compatible with the target, the reaction can be redirected onto a low-temperature pathway, enabling access to phases, stable or metastable, under temperature-time conditions that are otherwise impractical.

This chemistry-agnostic scope was illustrated beyond Ni-rich Li layered oxides using two distinct cathode families. First, applying oxyhydroxide-enabled intermediate control to a Na-ion layered system yields a metastable Mn-rich O3-type cathode. This polymorph selection is nontrivial: for the Ni: Mn=½ composition, conventional synthesis most commonly converges on the thermodynamically stable P2 family, P2-NaₓNi_{0.33}Mn_{0.67}O₂ with x≤0.67, whereas O3 stacking is less frequently obtained without specific intermediate control. Here, Rietveld refinement confirms formation of phase pure O3 Na_{0.91}Ni_{0.33}Mn_{0.67}O₂ after processing at 450° C. for 12 h. The metastable O3 material delivers a first-discharge capacity of ~160 mAh/g with a first-cycle coulombic efficiency of ~93% (FIG. 29), demonstrating that nonequilibrium-intermediate control can access a metastable layered polymorph at reduced temperature.

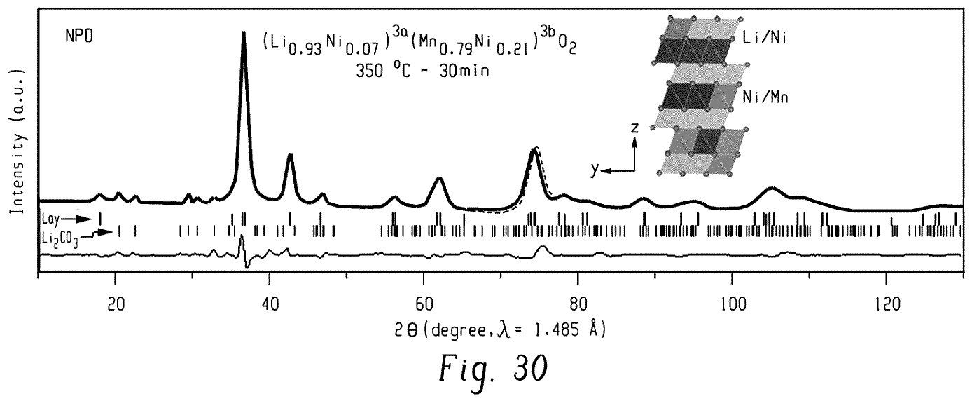

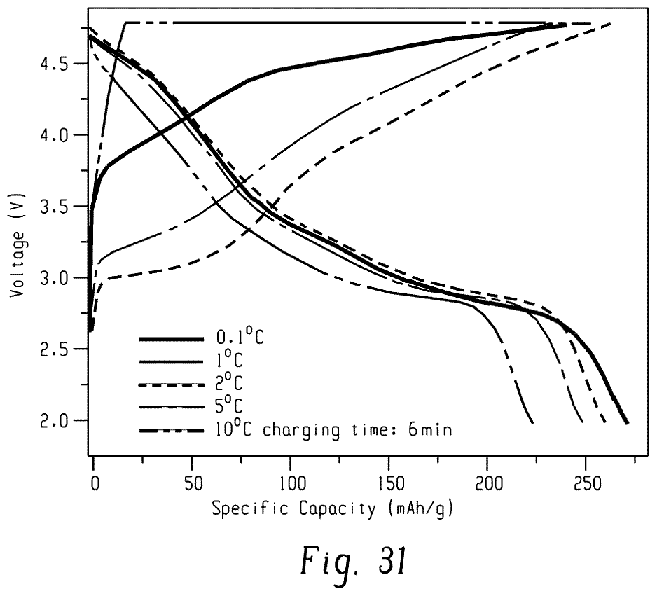

Second, the same oxyhydroxide-preconditioning strategy can be directed toward metastable Mn-rich lithium-deficient layered oxides on a markedly shortened timescale. A spinel (Li_{0.93}Ni_{0.07})^{3a}(Mn_{0.79}Ni_{0.21})^{3b}O₂ forms within 30 min at 350° C., with diffraction consistent with the R3m layered phase (FIG. 30). This rapidly synthesized metastable cathode delivers a high reversible capacity of 269 mAh/g at 0.1 C, and retains 222 mAh/g even under 10 C charging (total charge time ~6 min) (FIG. 31). Together, these demonstrations show that precursor preconditioning combined with nonequilibrium-intermediate design provides a transferable handle for rapid, low-temperature cathode synthesis across alkali chemistries (Li and Na), aligning directly with the concept of chemistry-agnostic cathode synthesis.

Experimental details follow.

Hydroxide precursors: Transition-metal hydroxide precursors were synthesized by a coprecipitation method. Example compositions include: Ni_{0.6}Mn_{0.2}Co_{0.2}(OH)₂, Ni_{0.8}Mn_{0.1}Co_{0.1}(OH)₂, and Ni_{0.8}Mn_{0.15}Al_{0.05}(OH)₂, Ni_{0.9}Mn_{0.1}(OH)₂, Ni_{0.9}Mn_{0.1}Co_{0.1}(OH)₂, Ni(OH)₂, Ni_{0.33}Mn_{0.67}(OH)₂, and Ni_{0.25}Mn_{0.75}(OH)₂.

Preconditioning of precursors (oxidation): Oxyhydroxide precursors were prepared by chemically oxidizing the corresponding hydroxide precursors using an oxidizing reagent. Suitable oxidizing reagents include sodium persulfate (Na₂S₂O₈), sodium hypochlorite (NaClO) (as powder or aqueous bleach solution), ozone (O₃), and other oxidative reagents.

Example oxidation using Na₂S₂O₈: A suspension containing 1M transition-metal hydroxide precursor was added to 500 mL of 1.2 M Na₂S₂O₈ aqueous solution (deionized (DI) water) together with 0.25 M NaOH. The resulting suspension was stirred at 350 rpm and 50° C. for 6 hours. The oxidized oxyhydroxide precursor was then collected by filtration, washed with DI water three times, and vacuum-dried at 50° C. overnight.

Using NaClO or bleach solution as another example: 1 M transition-metal hydroxide precursor was added to 625 mL of 7 wt % NaClO aqueous bleach solution (NaClO concentration ~1 M). The resulting suspension was stirred at 350 rpm and 50° C. for 8 hours. The oxidized oxyhydroxide precursor was then collected by filtration, washed with DI water three times, and vacuum-dried at 50° C. overnight.

The precursor color was typically observed to change to black after oxidation.

LiOH—H₂O infiltration of oxhydroxide precursors: Firstly, 1M TMOOH_{2-δ}precursor was manually mixed with 0.6 M LiOH·H₂O. The mixture was then immersed in 100 mL of 4.5 M LiOH aqueous solution such that the overall Li/TM molar ratio was 1:1.05. The slurry was dried on a hot plate at 80° C. to evaporate water. The dried material was collected and ground into a fine powder.

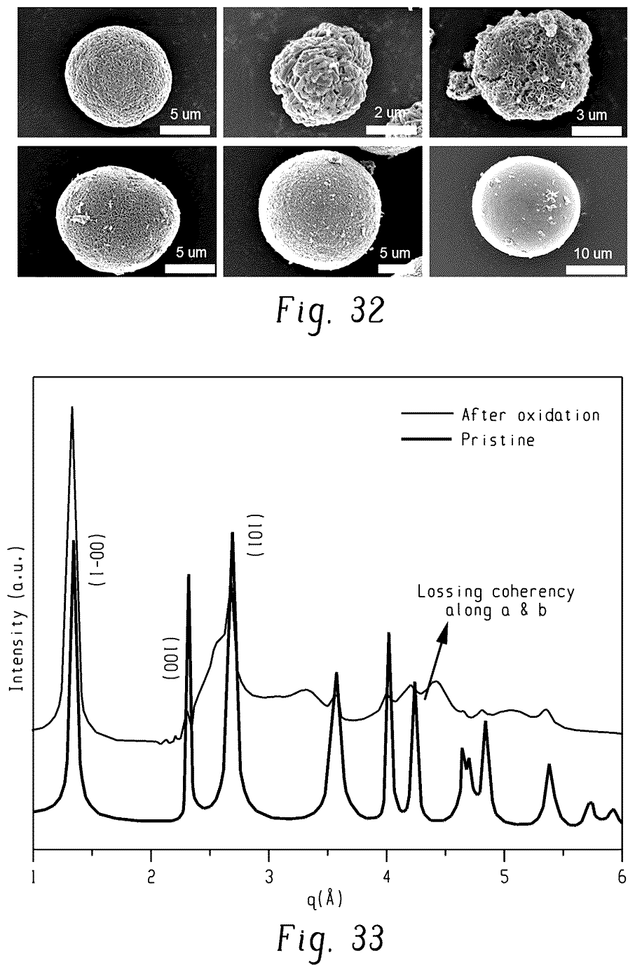

Scanning electron microscope (SEM) images of exemplary pretreated oxyhydroxide precursors are shown in FIG. 32 (top, left to right: Ni_{0.6}Mn_{0.2}Co_{0.2}OOH_{2-δ}, Ni_{0.8}Mn_{0.1}Co_{0.1}OOH_{2-δ}, and Ni_{0.8}Mn_{0.15}Al₀.₀₅OOH_{2-δ}; bottom, left to right: Ni_{0.9}Mn_{0.1}OOH_{2-δ}, Ni_{0.9}Mn_{0.1}Co_{0.1}OOH_{2-δ}, and NiOOH_{2-δ}). X-ray diffraction (XRD) of an exemplary pretreated oxyhydroxide precursor is shown in FIG. 33.

Low temperature calcination: The powder obtained from the last step was calcined at 475-600° C. for a selected duration in an electric furnace under flowing pure O₂ or dry air. Calcination time was adjusted based on temperature, with higher temperatures generally requiring shorter durations. Representative conditions include: 15 h at 475° C., 10 h at 550° C., and 0.5 to 3 h at 600° C.

This disclosure further encompasses the following aspects.

Aspect 1: A method for the manufacture of a cathode active material, the method comprising: contacting a transition metal oxyhydroxide with an alkali metal source under conditions effective to form an oxyhydroxide intermediate having alkali metal cations inserted therein; and heat treating the oxyhydroxide intermediate to form the cathode active material.

Aspect 2: The method of aspect 1, wherein the transition metal oxyhydroxide is obtained by oxidizing a transition metal hydroxide under conditions effective to provide the corresponding transition metal oxyhydroxide.

Aspect 3: The method of aspect 1 or 2, wherein the transition metal hydroxide is of the formula TM(OH)₂, wherein TM is a transition metal optionally in combination with a dopant, wherein the transition metal and the dopant comprising Ni, Co, Mn, Fe, Al, Mg, Ca, Sc, Ti, V, Cr, Cu, Zn, Ga, Ge, Y, Zr, Nb, Mo, Ru, Rh, Sn, Sb, Ir, Bi, Si, B Ce, La Ta, W, or a combination thereof.

Aspect 4: The method of any of aspects 1 to 3, wherein the transition metal oxyhydroxide is of the formula TMOOH_{2-δ}, wherein TM is a transition metal optionally in combination with a dopant, wherein the transition metal and the dopant comprising Ni, Co, Mn, Fe, Al, Mg, Ca, Sc, Ti, V, Cr, Cu, Zn, Ga, Ge, Y, Zr, Nb, Mo, Ru, Rh, Sn, Sb, Ir, Bi, Si, B Ce, La Ta, W, or a combination thereof, or a combination thereof, and wherein δ is 0<δ≤1.

Aspect 5: The method of any of aspects 1 to 4, wherein oxidizing the transition metal hydroxide comprises contacting the transition metal hydroxide with an oxidant, optionally under basic conditions.

Aspect 6: The method of any of aspects 1 to 5, wherein the alkali metal source is an alkali metal salt comprising K, Li, Na, or a combination thereof, preferably an alkali metal hydroxide.

Aspect 7: The method of any of aspects 1 to 6, wherein contacting the transition metal oxyhydroxide with the alkali metal source is at a temperature of 300° C. or less.

Aspect 8: The method of any of aspects 1 to 7, wherein contacting the transition metal oxyhydroxide with the alkali metal source comprises a topotactic alkali metal/hydrogen ion exchange that preserves a layered crystallographic stacking of the transition metal oxyhydroxide.

Aspect 9: The method of any of aspects 1 to 8, further comprising infiltrating the alkali metal source into a pore of the transition metal oxyhydroxide, wherein the alkali metal source is a hydrated alkali metal source.

Aspect 10: The method of any of aspects 1 to 9, wherein heat treating the oxyhydroxide intermediate is at a temperature of 400 to 650° C. and for a time of for 12 hours or less.

Aspect 11: The method of any of aspects 1 to 10, wherein the cathode active material is a layered cathode active material having an alkali metal/transition metal antisite mixing of less than or equal to 3%.

Aspect 12: The method of any of aspects 1 to 11, wherein the cathode active material is a spinel cathode active material.

Aspect 13: A cathode active material made by the method of any of aspects 1 to 12, wherein the cathode active material is a layered cathode active material having an alkali metal/transition metal antisite mixing of less than or equal to 3%.

Aspect 14: An oxyhydroxide metal composition of the formula TMOOH_{2-δ}, wherein TM is a transition metal optionally in combination with a dopant, and wherein δ is 0<δ≤1; wherein the oxyhydroxide metal composition comprises a plurality of secondary particles having an average particle size of 1 to 20 micrometers; and the oxyhydroxide metal composition comprises a plurality of crystalline domains having an average domain size of 10 to 30 nanometers.

Aspect 15: The oxyhydroxide metal composition of aspect 14, wherein the transition metal comprises Ni, Mn, Co, Al, or a combination thereof.

Aspect 16: The oxyhydroxide metal composition of aspect 14 or 15, wherein the transition metal comprises Ni; or Ni and Mn; or Ni, Mn, and Co.

Aspect 17: The oxyhydroxide metal composition of any of aspects 14 to 16, wherein the composition exhibits a layered crystallographic stacking topology characterized by preserved 00l reflections in X-ray diffraction.

Aspect 18: The oxyhydroxide metal composition of any of aspects 14 to 17, wherein the composition comprises Ni_{0.6}Mn_{0.2}Co_{0.2}OOH_{2-δ}, Ni_{0.8}Mn_{0.1}Co_{0.1}OOH_{2-δ}, Ni_{0.9}Mn_{0.1}Co_{0.1}OOH_{2-δ}, Ni_{0.8}Mn_{0.15}Al_{0.05}OOH_{2-δ}, NiOOH_{2-δ}, Ni_{0.6}Mn_{0.2}Co_{0.2}OOH_{2-δ}, Ni_{0.8}Mn_{0.1}Co_{0.1}OOH_{2-δ}, and Ni_{0.8}Mn_{0.15}Al_{0.05}OOH_{2-δ}, Ni_{0.9}Mn_{0.1}OOH_{2-δ}, Ni_{0.9}Mn_{0.1}Co_{0.1}OOH_{2-δ}, NiOOH_{2-δ}, Ni_{0.33}Mn_{0.67}OOH_{2-δ}, or Ni_{0.25}Mn_{0.75}OOH_{2-δ}.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for the manufacture of a cathode active material, the method comprising:
contacting a transition metal oxyhydroxide with an alkali metal source under conditions effective to form an oxyhydroxide intermediate having alkali metal cations inserted therein; and
heat treating the oxyhydroxide intermediate to form the cathode active material.

2. The method of claim 1, wherein the transition metal oxyhydroxide is obtained by oxidizing a transition metal hydroxide under conditions effective to provide the corresponding transition metal oxyhydroxide.

3. The method of claim 1, wherein the transition metal hydroxide is of the formula TM(OH)₂, wherein TM is a transition metal optionally in combination with a dopant, wherein the transition metal and the dopant comprise Ni, Co, Mn, Fe, Al, Mg, Ca, Sc, Ti, V, Cr, Cu, Zn, Ga, Ge, Y, Zr, Nb, Mo, Ru, Rh, Sn, Sb, Ir, Bi, Si, B Ce, La Ta, W, or a combination thereof.

4. The method of claim 1, wherein the transition metal oxyhydroxide is of the formula TMOOH_{2-δ}, wherein TM is a transition metal optionally in combination with a dopant, wherein the transition metal and the dopant comprise Ni, Co, Mn, Fe, Al, Mg, Ca, Sc, Ti, V, Cr, Cu, Zn, Ga, Ge, Y, Zr, Nb, Mo, Ru, Rh, Sn, Sb, Ir, Bi, Si, B Ce, La Ta, W, or a combination thereof, or a combination thereof, and wherein δ is 0<δ≤1.

5. The method of claim 1, wherein oxidizing the transition metal hydroxide comprises contacting the transition metal hydroxide with an oxidant, optionally under basic conditions.

6. The method of claim 1, wherein the alkali metal source is an alkali metal salt comprising K, Li, Na, or a combination thereof, preferably an alkali metal hydroxide.

7. The method of claim 1, wherein contacting the transition metal oxyhydroxide with the alkali metal source is at a temperature of 300° C. or less.

8. The method of claim 1, wherein contacting the transition metal oxyhydroxide with the alkali metal source comprises a topotactic alkali metal/hydrogen ion exchange that preserves a layered crystallographic stacking of the transition metal oxyhydroxide.

9. The method of claim 1, further comprising infiltrating the alkali metal source into a pore of the transition metal oxyhydroxide, wherein the alkali metal source is a hydrated alkali metal source.

10. The method of claim 1, wherein heat treating the oxyhydroxide intermediate is at a temperature of 400 to 650° C. and for a time of for 12 hours or less.

11. The method of claim 1, wherein the cathode active material is a layered cathode active material having an alkali metal/transition metal antisite mixing of less than or equal to 3%.

12. The method of claim 1, wherein the cathode active material is a spinel cathode active material.

13. A cathode active material made by the method of claim 1, wherein the cathode active material is a layered cathode active material having an alkali metal/transition metal antisite mixing of less than or equal to 3%.

14. An oxyhydroxide metal composition of the formula TMOOH_{2-δ}, wherein TM is a transition metal optionally in combination with a dopant, and wherein δ is 0<δ≤1; wherein
the oxyhydroxide metal composition comprises a plurality of secondary particles having an average particle size of 1 to 20 micrometers; and
the oxyhydroxide metal composition comprises a plurality of crystalline domains having an average domain size of 10 to 30 nanometers.

15. The oxyhydroxide metal composition of claim 14, wherein the transition metal comprises Ni, Mn, Co, Al, or a combination thereof.

16. The oxyhydroxide metal composition of claim 14, wherein the transition metal comprises Ni; or Ni and Mn; or Ni, Mn, and Co.

17. The oxyhydroxide metal composition of claim 14, wherein the composition exhibits a layered crystallographic stacking topology characterized by preserved 00l reflections in X-ray diffraction.

18. The oxyhydroxide metal composition of claim 14, wherein the composition is in the form of a plurality of secondary particles having an average particle size of 3 to 20 micrometers.

19. The oxyhydroxide metal composition of claim 14, wherein the composition comprises Ni_{0.6}Mn_{0.2}Co_{0.2}OOH_{2-δ}, Ni_{0.8}Mn_{0.1}Co_{0.1}OOH_{2-δ}, Ni_{0.9}Mn_{0.1}Co_{0.1}OOH_{2-δ}, Ni_{0.8}Mn_{0.15}Al_{0.05}OOH_{2-δ}, NiOOH_{2-δ}, Ni_{0.6}Mn_{0.2}Co_{0.2}OOH_{2-δ}, Ni_{0.8}Mn_{0.1}Co_{0.1}OOH_{2-δ}, and Ni_{0.8}Mn_{0.15}Al_{0.05}OOH_{2-δ}, Ni_{0.9}Mn_{0.1}OOH_{2-δ}, Ni_{0.9}Mn_{0.1}Co_{0.1}OOH_{2-δ}, NiOOH_{2-δ}, Ni_{0.33}Mn_{0.67}OOH_{2-δ}, or Ni_{0.25}Mn_{0.75}OOH_{2-δ}.
